(19) United States
(12) Patent Application Publication
(10) Pub. No.: US 2026/0309557 A1
(43) Pub. Date: Oct. 8, 2026

(54) Single-Beam, 6-axis Force/Torque Sensor

(71) Applicant: ATI Industrial Automation, Inc., Apex, NC (US)

(72) Inventor: Joseph Lipsey, Lillington, NC (US)

(21) Appl. No.: 19/632,705

(22) Filed: Mar. 30, 2026

Related U.S. Application Data
(60) Provisional application No. 63/783,427, filed on Apr. 4, 2025.

(51) Int. Cl. G01L 1/22; G01L 3/10; G01L 5/00

(52) U.S. Cl. CPC G01L 1/2281; G01L 3/108; G01L 5/0076

(57) ABSTRACT

A 6-axis force and torque (F/T) sensor includes a first and second adapters configured to be connected to first and second objects, respectively. The F/T sensor further includes a single, multi-segment deformable beam connecting the first adapter to the second adapter. The deformable beam comprises a plurality of segments, each extending in a direction orthogonal to connecting segment(s). A first pair of strain gages is affixed to only one side of a first deformable beam segment, and a second pair of strain gages is affixed to only one side of a second deformable beam segment. The first and second pairs of strain gages lie in the same plane but oriented in orthogonal directions. A third pair of strain gages is affixed to only one side of a third deformable beam segment, in a plane orthogonal to that of the first and second pairs of strain gages.

### RELATED APPLICATIONS

This application claims the benefit of U.S. Provisional Application No. 63/783427, filed Apr. 4, 2025, the entire disclosure of which being hereby incorporated by reference herein.

### FIELD OF DISCLOSURE

The present disclosure relates generally to robotics, and in particular to a 6-axis force/torque sensor having a single, multi-segment deformable beam.

### BACKGROUND

Force and/or torque (F/T) sensors are well known in the robotic arts. F/T sensors measure forces and torques experienced by robotic arms, and provide these data to robotic control systems. F/T feedback and monitoring is critical to many robotic operations. For example, in force-controlled operations such as material removal (drilling, grinding, polishing, and the like), an F/T sensor affixed to the robot arm senses the actual force with which a robotic tool is applied to a workpiece, and the robot arm (or a compliance structure) is controlled to maintain the contact force at or below a setpoint. Examples of multi-axis F/T sensors and F/T resolution techniques include those described in U.S. Patent Nos. 10,422,707; 10,067,019; 11,892,364; 11,747,224; 11,491,663; 11,085,838; and published U.S. Patent Application No. 2023/0049155, all assigned to the assignee of the present disclosure and incorporated herein by reference in their entireties.

In particular, the ‘707 patent discloses a compact F/T sensor, arranged as a hub and annular ring connected by deformable beams, similar to the spokes of a wheel. The F/T sensor of the ‘707 patent may be machined from a single piece of metal, reducing parts count and easing manufacturing. Strain gages are affixed to only one (upper) side of each deformable beam, on opposite sides of a neutral axis, further facilitating a compact design, and reducing manufacturing costs by easing the task of strain gage attachment. Strain-enhancing holes may be formed between the strain gages of each pair. While the F/T sensor of the ‘707 patent provides an excellent F/T measurement solution for many use cases, force and torque resolution from strain gage signal measurements benefit if the strain gages are not all co-planar.

The Background section of this document is provided to place aspects of the present disclosure in technological and operational context, to assist those of skill in the art in understanding their scope and utility. Approaches described in the Background section could be pursued, but are not necessarily approaches that have been previously conceived or pursued. Unless explicitly identified as such, no statement herein is admitted to be prior art merely by its inclusion in the Background section.

### SUMMARY

The following presents a simplified summary of the disclosure in order to provide a basic understanding to those of skill in the art. This summary is not an extensive overview of the disclosure and is not intended to identify key/critical elements of aspects of the disclosure or to delineate the scope of the disclosure. The sole purpose of this summary is to present some concepts disclosed herein in a simplified form as a prelude to the more detailed description that is presented later.

According to one or more aspects described and claimed herein, a 6-axis F/T sensor comprises first and second mounting adapters, each configured to be rigidly affixed to respective first and second objects. A single, multi-segment deformable beam, comprising a plurality of segments, connects the first and second mounting adapters. Each segment of the multi-segment deformable beam extends parallel to an axis of a Cartesian coordinate frame of the F/T sensor; hence, each beam segment extends in a direction orthogonal to that of the segment(s) to which it is connected. In one embodiment, the first and second mounting adapters are disposed adjacent and spaced apart from each other, e.g., in the y-direction, and the multi-segment deformable beam extends around the pair mounting adapters, with each segment parallel to the x- or y-axis of the F/T sensor coordinate frame. Each beam segment thus connects to one or two adjacent beam segments at a right angle. The multi-segment deformable beam comprises connecting beam segments connected to the first and second mounting adapters, and three deformable beam segments connected between the first and second connecting beam segments. Strain gages are affixed to only one surface of a plurality of selected deformable beam segments, on either side of a neutral axis. The deformable beam segment surfaces to which strain gages are attached are readily accessible (i.e., the strain gages are not affixed to an “interior” surface of a deformable beam segment, between the multi-segment deformable beam and the first and second mounting adapters). Strain-enhancing through-passages are optionally formed in the selected deformable beam segments, below the strain gages. The deformable beam segment surfaces on which strain gages are affixed each defines a plane. The first and second pair of strain gages are affixed to respective deformable beam segment surfaces in the same plane, but oriented in orthogonal directions. The third pair of strain gages is affixed to a deformable beam segment surfaces in the a plane orthogonal to that of the first and second strain gage pairs.

One aspect relates to a 6-axis force and torque (F/T) sensor. The F/T sensor includes a first adapter configured to be connected to a first object and a second adapter configured to be connected to a second object. The F/T sensor further includes a single, multi-segment deformable beam connecting the first adapter to the second adapter. The deformable beam comprises a plurality of segments. Each segment extends in a direction orthogonal to connecting segment(s). A first pair of strain gages is affixed to only one side of a first deformable beam segment. A second pair of strain gages is affixed to only one side of a second deformable beam segment. The first and second pairs of strain gages lie in the same plane but are oriented in orthogonal directions. A third pair of strain gages is affixed to only one side of a third deformable beam segment. The third pair of strain gages lies in a plane orthogonal to that of the first and second pairs of strain gages.

### BRIEF DESCRIPTION OF THE DRAWINGS

The present disclosure will now be described more fully hereinafter with reference to the accompanying drawings, in which aspects of the disclosure are shown. However, this disclosure should not be construed as limited to the aspects set forth herein. Rather, these aspects are provided so that this disclosure will be thorough and complete, and will fully convey the scope of the disclosure to those skilled in the art. Like numbers refer to like elements throughout.

FIG. 1 is a perspective view of the top side of a 6-axis F/T sensor having a single deformable beam, with one pair of strain gages on the same surface of each of selected deformable beam segments.

FIG. 2 is a perspective view of the bottom side of the F/T sensor of FIG. 1.

FIG. 3 is a schematic diagram of a quarter-bridge wiring of a pair of strain gages.

FIG. 4 is a perspective view of the top side of a 6-axis F/T sensor having a single deformable beam, with two pairs of strain gages on the same surface of each of selected deformable beam segments.

FIG. 5 is a schematic diagram of a quarter-bridge wiring of a pair of strain gages.

FIG. 6 is a schematic diagram of a quarter-bridge wiring of a pair of strain gages.

FIG. 7 is a block diagram of the controller electronics of the F/T sensor of FIG. 1.

### DETAILED DESCRIPTION

For simplicity and illustrative purposes, the present disclosure is described by referring mainly to an exemplary aspect thereof. In the following description, numerous specific details are set forth in order to provide a thorough understanding of the present disclosure. However, it will be readily apparent to one of ordinary skill in the art that the present disclosure may be practiced without limitation to these specific details. In this description, well known methods and structures have not been described in detail so as not to unnecessarily obscure the present disclosure.

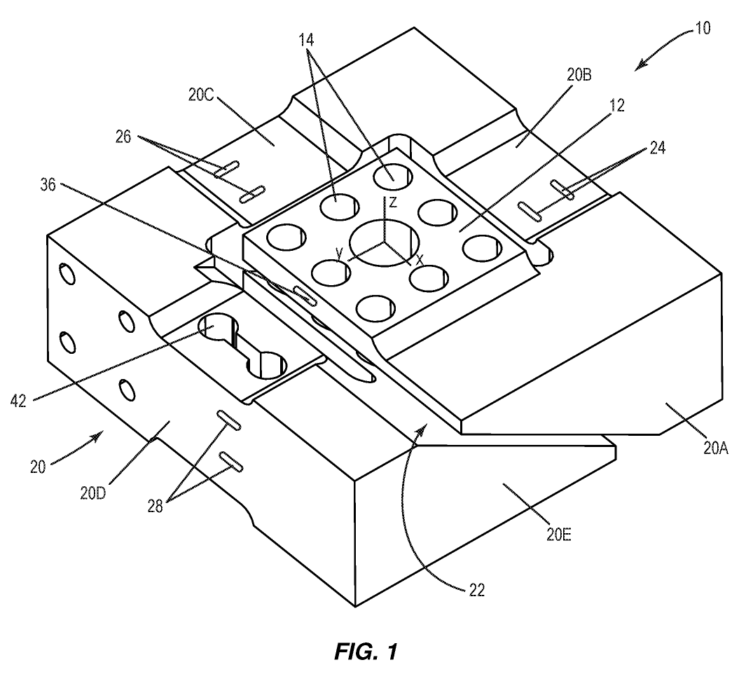

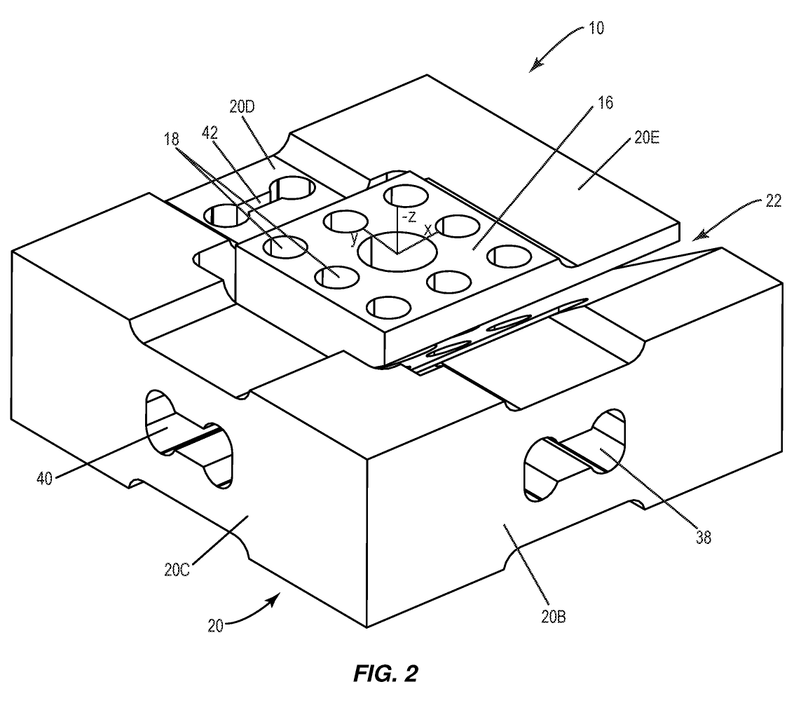

FIG. 1 is a perspective view from the top of a single-beam, 6-axis F/T sensor 10 according to one aspect of the present disclosure. FIG. 2 is a perspective view from the bottom of the same F/T sensor 10. The F/T sensor 10 includes first and second mounting adapters 12, 16; a single, multi-segment deformable beam 20 connecting the first adapter 12 to the second adapter 16, and three pairs of strain gages 24, 26, 28, each affixed to only one side of respective first, second, and third deformable beam segments 20B, 20C, and 20D. FIGS. 1 and 2 show a Cartesian coordinate reference frame, for the purpose of discussion herein only.

A first mounting adapter 12 is configured to be rigidly affixed to a first object, such as a robot arm. Mounting through-holes 14 are provided in a regular pattern on the first mounting adapter 12, facilitating connection of the first mounting adapter 12 to a variety of robot arms or adapters. In other aspects, the mounting holes 14 may be threaded, and/or may be provided in a different pattern. A second mounting adapter 16 is configured to be rigidly affixed to a second object, such as a robotic tool or end effector. Mounting through-holes 18 are provided in a regular pattern, on the second mounting adapter 16, facilitating connection of the second mounting adapter 16 to a variety of robotic tools or end effectors. In other aspects, the mounting holes 18 may be threaded, and/or may be provided in a different pattern. The first and second mounting adapters 12, 16 (as well as connecting beam segments 20A, 20E) are separated by a diagonal gap 22, and hence have no direct contact with each other.

A single, multi-segment deformable beam 20 connects the first mounting adapter 12 to the second mounting adapter 16. The multi-segment deformable beam 20 comprises a plurality of beam segments, each extending in a direction orthogonal to connecting beam segment(s). In particular, the multi-segment deformable beam 20 comprises first and second connecting beam segments 20A, 20E, which connect to the first and second mounting adapters 12, 16, respectively. Like the first and second mounting adapters 12, 16, the first and second connecting beam segments 20A, 20E are separated by a diagonal gap 22, and hence do not contact each other. A plurality of deformable beam segments 20B, 20C, 20D connect the first connecting beam segment 20A to the second connecting beam segment 20E. No deformable beam segment 20B, 20C, 20D contacts either the first or second mounting adapter 12, 16. Rather, the deformable beam segments 20B, 20C, 20D extend around the first and second mounting adapters 12, 16, separated therefrom by a small gap. All beam segments 20A-E connect to adjacent beam segment(s) at right angles.

In greater detail, the first connecting beam segment 20A extends in the -y direction from the first mounting adapter 12. A first deformable beam segment 20B extends in the -x direction from the first connecting beam segment 20A. A second deformable beam segment 20C connects to the first deformable beam segment 20B at a right angle, and extends in the +y direction. A third deformable beam segment 20D connects to the second deformable beam segment 20C at a right angle, and extends in the +x direction. Finally, the second connecting beam segment 20E connects to the third deformable beam segment 20D at a right angle, extends in the -y direction, and connects to the second mounting adapter 16.

In one aspect, strain gages 24, 26, 28 are affixed in pairs to only one side of each of the three deformable beam segments 20B-D. The strain gages of each pair are affixed to a surface of a deformable beam segment on opposite sides of, and spaced apart from, a neutral axis of that surface of the beam segment. The neutral axis is the line, running generally down the center of the surface of the beam segment, at which compressive strain experienced on the left side of the beam segment transitions to tensile strain on the right side. Accordingly, the beam segment undergoes no strain at the neutral axis. Each strain gage is rigidly affixed to the surface of a beam segment, such as by adhesive, so that tensile and compressive forces at the surface of the beam segment are transferred to the strain gage, which experiences a change in electrical resistivity proportionate to the strain. The strain gages are arranged in a direction along the length of the respective beam segment – that is, parallel to the neutral axis of the beam segment surface.

In particular, a first pair of strain gages 24 is affixed to the upper surface of the first deformable beam segment 20B. A second pair of strain gages 26 is affixed to the upper surface of the second deformable beam segment 20C. A third pair of strain gages 28 is affixed to the outer surface of the third deformable beam segment 20D.

The first and second pairs of strain gages 24, 26 lie in the same plane (the x-y plane), but are oriented in orthogonal directions – the first pair of strain gages 24 is oriented parallel to the x-axis and the second pair of strain gages 26 is oriented parallel to the y-axis. The third pair of strain gages 28 is also affixed oriented parallel to the x-axis; however, the third pair of strain gages 28 lies in a plane (the x-z plane) orthogonal to that of the first and second pairs of strain gages 24, 26.

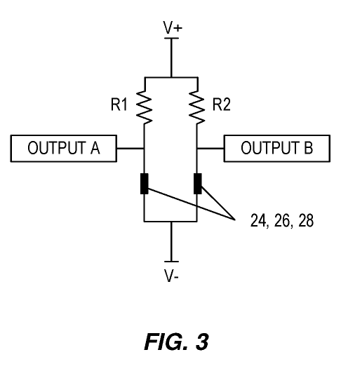

In the aspect depicted in FIG. 1, each pair of strain gages 24, 26, 28 on each deformable beam segment 20B-D is wired in a quarter-bridge topology, using two fixed resistors, as depicted in FIG. 3.

One or more additional strain gages 36 may be affixed to a non-stressed member, such as a side of the first mounting adapter 12, as shown in FIG. 1. Because it experiences no mechanical strain, the output of this strain gage 36 varies only with temperature, and may provide information for performing temperature compensation of the pairs of strain gages 24, 26, 28. Temperature compensation is described, for example, in several of the above-incorporated patents.

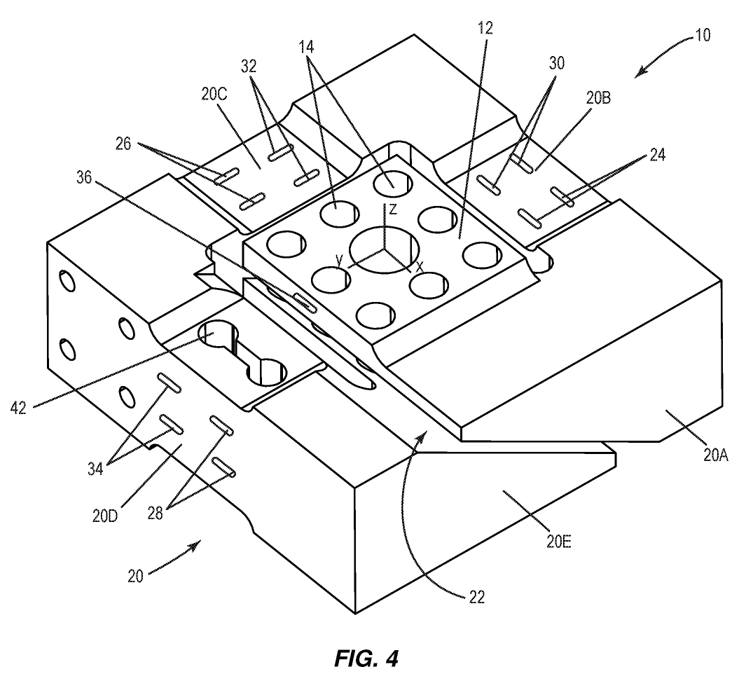

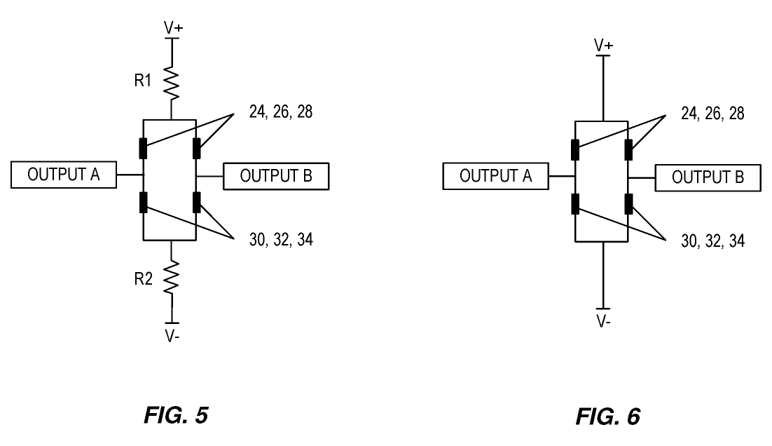

FIG. 4 depicts another aspect of the single-beam, 6-axis F/T sensor 10, in which two pairs of strain gages are affixed to each beam surface to be instrumented. In particular, a fourth pair of strain gages 30 is affixed to the upper surface of the first deformable beam segment 20B, generally aligned with the first pair of strain gages 24. A fifth pair of strain gages 32 is affixed to the upper surface of the second deformable beam segment 20C, generally aligned with the second pair of strain gages 26. A sixth pair of strain gages 34 is affixed to the outer surface of the third deformable beam segment 20D, generally aligned with the third pair of strain gages 28. In this aspect, the four strain gages on each deformable beam segment are wired in half bridge topology with span resistors R1, R2, as depicted in FIG. 5.

In another aspect (not shown), the fourth, fifth, and sixth pairs of strain gates 30, 32, 34 are mounted on the opposite sides of the first, second, and third deformable beam segments 20B-D to the first, second, and third pairs of strain gages 24, 26, 28. In this aspect, the four strain gages on each deformable beam segment are wired in full bridge topology, as depicted in FIG. 6.

In one aspect, as best seen in FIG. 2, each deformable beam segment 20B-D includes a through-passage 38, 40, 42, respectively. Although these may functionally be virtually any shape, FIGS. 1, 2, and 4 depict a “dog-bone” shape, comprising two round or oval through-holes, connected by a straight through-cut. Strain gage pairs 24, 26, 28, 30, 32, 34 are preferably affixed over one of the through-holes (as shown in FIG. 1, for strain gages 28 and through-passage 42). This reduces the thickness of the respective deformable beam segment 20B-D, enhancing the strain exhibited at the adjacent surface, where the strain gage pairs 24, 26, 28, 30, 32, 34 are affixed. The dual through-hole design of the through-passages facilitates the aspect shown in FIG. 4, wherein two pairs of strain gages are mounted on each instrumentation surface of the deformable beam segment 20B-D (and potentially also on the opposite sides of the beam segments, yielding up to four pairs of strain gages per beam segment, which may be wired in a full bridge topology). The connecting through-cuts ensure that if strain gages are affixed over both through-holes, they experience the same amount of strain, because if the area between the holes were solid, strain could transfer from the left side to the right side of the beam segment, between the pairs of gages.

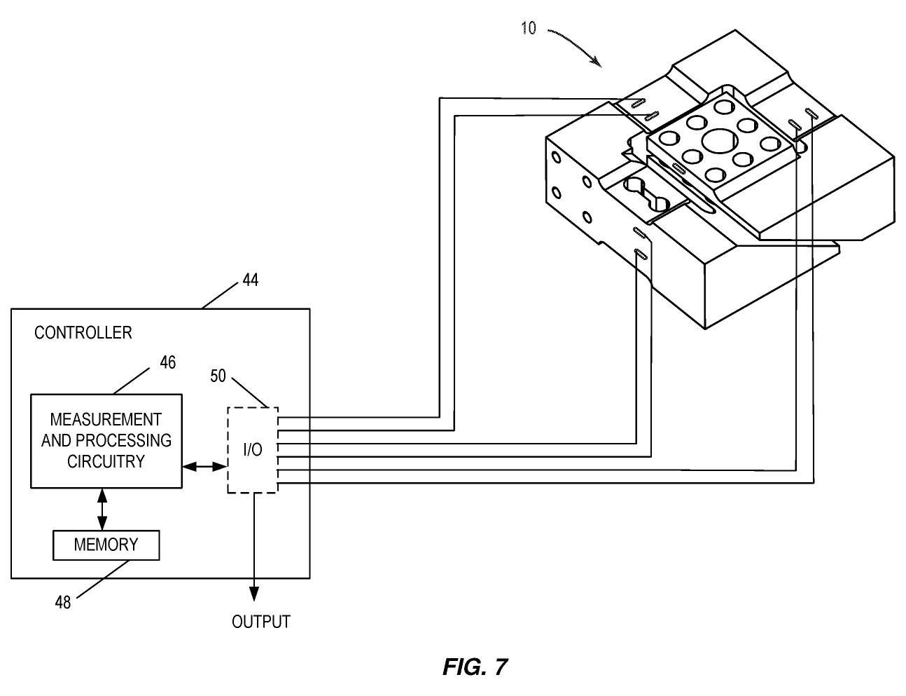

FIG. 7 shows the F/T sensor 10 with a block diagram of a controller 44, which includes measurement and processing circuitry 46, memory 48, and optionally (as indicated by dashed lines) Input/Output (I/O) circuitry 50. The measurement and processing circuitry 46 is configured to receive electrical signals from each strain gage of pairs 24, 26, 28, 30, 32, 34 (only strain gage pairs 24, 26, 28 shown for simplicity) and to resolve the signals into forces and/or torques applied between the first and second mounting adapters 12, 16. In one aspect, the forces are aligned along the F/T sensor coordinate axes, as shown in FIG. 1, and the torques are moments about those axes, yielding a 6-axis F/T output. Algorithms for resolving strain gage outputs into forces and torques are known in the art, and are disclosed, for example, in the above incorporated patents. These algorithms may be embodied in machine-readable code stored in memory 48, which is accessed by the measurement and processing circuitry 46. Although not shown in FIG. 6, one or more non-stressed, temperature compensation strain gages 36 may also connect to the controller 44, and the measurement and processing circuitry 46 may additionally perform temperature compensation on the force and torque values derived from the strain gage pairs 24, 26, 28, 30, 32, 34.

Optional I/O circuitry 50 may pre-process the strain gage output signals prior to their processing by the measurement and processing circuitry 46, such as by amplifying, low-pass filtering to reduce noise, and performing analog to digital conversion. The I/O circuity 50 may also post-process the resolved forces and torques, such as by comparing them to predetermined thresholds to emit an alarm if excessive force or torque is detected, by transforming the forces and torques to a format required by, e.g., haptic feedback circuitry in a robotic controller, or for other uses. Alternatively, the measurement and processing circuitry 46 may perform all formatting of the output data.

The measurement and processing circuitry 46 may comprise any sequential state machine operative to execute machine instructions stored as machine-readable computer programs in memory 48, such as one or more hardware-implemented state machines (e.g., in discrete logic, FPGA, ASIC, etc.), programmable logic together with appropriate firmware; one or more stored-program, general-purpose processors, such as a microprocessor or Digital Signal Processor (DSP), together with appropriate software; or any combination of the above.

The memory 48 may comprise any non-transitory machine-readable media known in the art or that may be developed, including but not limited to magnetic media (e.g., floppy disc, hard disc drive, etc.), optical media (e.g., CD-ROM, DVD-ROM, etc.), solid state media (e.g., SRAM, DRAM, DDRAM, ROM, PROM, EPROM, Flash memory, solid state disc, etc.), or the like. Those of skill in the art understand that in some aspects, the memory 48 may be integrated into the measurement and processing circuitry 46.

The optional I/O circuitry 50 may comprise receiver circuitry configured to receive, amplify, and digitize electrical signals from strain gage pairs 24, 26, 28, 30, 32, 34. The I/O circuitry 50 may additionally include transmitter or interface circuitry configured to output useful force/torque data to other systems or components, such as an excessive force indicator (e.g., flashing light, audible alarm, or the like), as data for a haptic feedback system, or the like.

Embodiments of the present disclosure present significant advantages over the prior art, and may achieve one or more of the following technical effects. The F/T sensor is compact, allowing for it deployment in numerous robotic operations requiring small, agile robots, such as warehouse automation. By affixing strain gages only to the upper or outer surfaces of deformable beam segments, manufacturing cost is reduced and yield improved. Orienting two pairs of strain gages in different directions, and a third pair in a plane orthogonal to that of the other two pair, the signals from the strain gages are more easily resolved into six axes of forces and torques experienced by the F/T sensor. Mounting one or more strain gages in an unstressed location facilitates temperature compensation, improving accuracy over a wide range of operating conditions.

Although described herein in terms of strain gages as stress transducers, those of skill in the art understand that other technologies may be advantageously deployed in the inventive F/T sensor. For example, capacitive gages, fiber Bragg grating, Surface Acoustic Wave (SAW) or piezoelectric sensors, or any combinations thereof may be deployed as stress transducers.

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. Any feature of any of the aspects disclosed herein may be applied to any other aspect, wherever appropriate. Likewise, any advantage of any of the aspects may apply to any other aspects, and vice versa. Other objectives, features, and advantages of the enclosed aspects will be apparent from the description. As used herein, the term “configured to” means set up, organized, adapted, or arranged to operate in a particular way; the term is synonymous with “designed to,” or in the case of processing circuitry and/or software, “programmed to.”

The present disclosure may, of course, be carried out in other ways than those specifically set forth herein without departing from essential characteristics of the disclosure. The present aspects are to be considered in all respects as illustrative and not restrictive, and all changes coming within the meaning and equivalency range of the appended claims are intended to be embraced therein.

What is claimed is:

1. A single-beam, 6-axis force and torque (F/T) sensor, comprising:
a first mounting adapter configured to be rigidly affixed to a first object:
a second mounting adapter configured to be rigidly affixed to a second object;
a single, multi-segment deformable beam connecting the first mounting adapter to the second mounting adapter, the multi-segment deformable beam comprising a plurality of beam segments, each extending in a direction orthogonal to connecting beam segment(s);
a first pair of strain gages affixed to only one side of a first deformable beam segment and a second pair of strain gages affixed to only one side of a second deformable beam segment, wherein the first and second pairs of strain gages lie in a same plane but are oriented in orthogonal directions; and
a third pair of strain gages affixed to only one side of a third deformable beam segment, wherein the third pair of strain gages lies in a plane orthogonal to that of the first and second pairs of strain gages.

2. The F/T sensor of claim 1 wherein the strain gages in each pair of strain gages are disposed on opposite sides of, and spaced apart from, a neutral axis of the respective deformable beam segment and are configured to transduce tensile and compressive forces on a surface of the one side of the respective deformable beam segment, caused by deformation of the respective deformable beam segment, into electrical signals.

3. The F/T sensor of claim 1 further comprising:
a measurement circuit configured to measure, in response to electrical signals from all strain gages, a direction and magnitude of three forces and three torques between the first and second objects, the forces and torques referenced to a coordinate frame of the F/T sensor.

4. The F/T sensor of claim 3, further comprising at least one temperature compensation strain gage affixed to a surface of the F/T sensor that does not experience mechanical stress in response to forces or torques applied to the F/T sensor, and wherein the measurement circuit is further configured to perform temperature compensation on measured forces and torques in response to a signal from the temperature compensation strain gage(s).

5. The F/T sensor of claim 1, wherein at least one deformable beam segment comprises a strain-concentrating through-passage formed through the deformable beam segment below the strain gages.

6. The F/T sensor of claim 1, wherein the multi-segment deformable beam further comprises a first connecting beam segment connected to the first mounting adapter and the first deformable beam segment, and a second connecting beam segment connected to the third deformable beam segment and the second mounting adapter.

7. The F/T sensor of claim 1 wherein the first and second mounting adapters and the multi-segment deformable beam are all machined from a single piece of metal stock and form an integral unit.

8. The F/T sensor of claim 1 wherein each pair of strain gages affixed to a deformable beam segment are electrically connected in quarter-bridge topology with two fixed resistors.

9. The F/T sensor of claim 1 further comprising
a fourth pair of strain gages affixed to the same side of the first deformable beam segment as the first pair of strain gages, and a fifth pair of strain gages affixed to the same side of the second deformable beam segment as the second pair of strain gages, wherein the fourth and fifth pairs of strain gages lie in a same plane but are oriented in orthogonal directions; and
a sixth pair of strain gages affixed to the same side of the third deformable beam segment as the third pair of strain gages, wherein the sixth pair of strain gages lies in a plane orthogonal to that of the fourth and fifth pairs of strain gages.

10. The F/T sensor of claim 9 wherein the two pairs of strain gages affixed to each deformable beam segment are electrically connected in half-bridge topology with span resistors.

11. The F/T sensor of claim 1 further comprising
a fourth pair of strain gages affixed to the opposite side of the first deformable beam segment as the first pair of strain gages, and a fifth pair of strain gages affixed to the opposite side of the second deformable beam segment as the second pair of strain gages, wherein the fourth and fifth pairs of strain gages lie in a same plane but are oriented in orthogonal directions; and
a sixth pair of strain gages affixed to the opposite side of the third deformable beam segment as the third pair of strain gages, wherein the sixth pair of strain gages lies in a plane orthogonal to that of the fourth and fifth pairs of strain gages.

12. The F/T sensor of claim 9 wherein the two pairs of strain gages affixed to each deformable beam segment are electrically connected in full-bridge topology.
